(19) United States
(12) Patent Application Publication
(10) Pub. No.: US 2019/0074504 A1
(43) Pub. Date: Mar. 7, 2019

(54) METHOD FOR PRODUCING ANODE FOR AQUEOUS LITHIUM ION SECONDARY BATTERY, AND METHOD FOR PRODUCING AQUEOUS LITHIUM ION SECONDARY BATTERY

(71) Applicant: TOYOTA JIDOSHA KABUSHIKI KAISHA, Toyota-shi (JP)

(72) Inventors: Takeshi TOJIGAMORI, Susono-shi (JP); Hiroshi SUYAMA, Mishima-shi (JP)

(73) Assignee: TOYOTA JIDOSHA KABUSHIKI KAISHA, Toyota-shi (JP)

(21) Appl. No.: 16/047,294

(22) Filed: Jul. 27, 2018

(30) Foreign Application Priority Data
Sep. 4, 2017 (JP) 2017-169720

(51) Int. Cl. H01M 4/04; H01M 10/38; H01M 4/485

(52) U.S. Cl. CPC H01M 4/0452; H01M 2004/027; H01M 4/485; H01M 10/38

(57) ABSTRACT

Disclosed is a method for producing an anode that can suppress decomposition of an aqueous electrolyte solution when the anode is applied to an aqueous lithium ion secondary battery, the method being for producing an anode for an aqueous lithium ion secondary battery, the method including: a first step of touching an anode that is electrochemically kept in a reduction or oxidation state to a nonaqueous electrolyte solution in which a lithium salt is dissolved, to form a film over a surface of the anode; and a second step of cleaning the anode, over the surface of which the film is formed.

### FIELD

The present application discloses a method for producing an anode that is used for an aqueous lithium ion secondary battery etc.

### BACKGROUND

A lithium ion secondary battery that contains a flammable nonaqueous electrolyte solution is equipped with a lot of members for safety measures, and as a result, an energy density per volume as a whole of the battery becomes low, which is problematic. In contrast, a lithium ion secondary battery that contains a nonflammable aqueous electrolyte solution does not need safety measures as described above, and thus has various advantages such as a high energy density per volume (Patent Literatures 1 to 3 etc.). However, a conventional aqueous electrolyte solution has a problem of a narrow potential window, which restricts active materials etc. that can be used.

As one means for solving the above described problem that the aqueous electrolyte solution has, Non Patent Literature 1 discloses that dissolving a high concentration of lithium bis(trifluoromethanesulfonyl)imide (hereinafter may be referred to as “LiTFSI”) in an aqueous electrolyte solution can expand the range of a potential window of the aqueous electrolyte solution. In Non Patent Literature 1, such an aqueous electrolyte solution of a high concentration, LiMn₂O₄ as the cathode active material, and Mo₆S₈ or the like as the anode active material are combined, to form an aqueous lithium ion secondary battery.

Non Patent Literature 2 discloses an aqueous electrolyte solution of a high concentration, called a hydrate melt, which is formed by mixing two specific lithium salts, and water in predetermined proportions. In Non Patent Literature 2, charge and discharge of an aqueous lithium ion secondary battery are confirmed under the use of an anode active material that is difficult to be used in a conventional aqueous lithium ion battery by using such an aqueous electrolyte solution of a high concentration.

### CITATION LIST

### Patent Literature

Patent Literature 1: JP 2006-066085 A
Patent Literature 2: JP 2007-123093 A
Patent Literature 3: JP 2009-094034 A

### Non Patent Literature

Non Patent Literature 1: Liumin Suo, et al., Advanced High-Voltage Aqueous Lithium-Ion Battery Enabled by “Water-in-Bisalt” Electrolyte, Angew. Chem. Int. Ed., vol. 55, 7136-7141(2016)
Non Patent Literature 2: Yuki Yamada et al., “Hydrate-melt electrolytes for high-energy-density aqueous batteries”, NATURE ENERGY (26 Aug. 2016)

### SUMMARY

### Technical Problem

While a potential window of an aqueous electrolyte solution on the reduction side expands to approximately 1.83 V vs Li/Li+ by dissolving a lithium salt of a high concentration, it is difficult to use an anode active material to charge and discharge lithium ions at a potential baser than this. The aqueous lithium ion secondary batteries of Non Patent Literatures 1 and 2 still have restrictions on active materials that can be used etc., and have a low voltage (operating voltage), which is problematic.

### Solution to Problem

The present application discloses a method for producing an anode for an aqueous lithium ion secondary battery, the method comprising: a first step of touching an anode that is electrochemically kept in a reduction or oxidation state to a nonaqueous electrolyte solution in which a lithium salt is dissolved, to form a film over a surface of the anode; and a second step of cleaning the anode, over the surface of which the film is formed, as one means for solving the above described problem.

“Nonaqueous electrolyte solution in which a lithium salt is dissolved” is an electrolyte solution that contains nonaqueous solvent (organic solvent) as solvent in which the lithium salt is dissolved as an electrolyte.

“Anode that is electrochemically kept in a reduction or oxidation state” means that the potential of the anode is kept at a predetermined reduction or oxidation potential. In the producing method of the present disclosure, touching the anode that is electrochemically kept in the reduction or oxidation state to the nonaqueous electrolyte solution chemically changes, for example, components contained in the nonaqueous electrolyte solution over the surface of the anode, to form a film over the surface of the anode.

“Film” is a film derived from components contained in the nonaqueous electrolyte solution, which has lower electron conductivity than an anode active material included in the anode.

Preferably, in the method for producing an anode of this disclosure, the nonaqueous electrolyte solution contains at least one organic compound selected from the group consisting of organic compounds each having a vinyl group, organosilicon compounds each including a carbon atom linked to a silicon atom that is next to the carbon atom, the carbon atom having a triple bond or a double bond, and organophosphorus compounds each including two or more oxygen atoms linked to a phosphorus atom that is next to the oxygen atoms.

Preferably, in the method for producing an anode of this disclosure, the organic compounds each having a vinyl group are at least one organic compound selected from the group consisting of vinylimidazole, vinylpyridine, methyl methacrylate, and styrene, the organosilicon compounds are at least one organic compound selected from the group consisting of 1,4-bis(trimethylsilyl)-1,3-butadiyne, trimethylsilylacetylene, trimethoxyphenylsilane, and triethoxyphenylsilane, and the organophosphorus compounds are at least one organic compound selected from the group consisting of (aminomethyl)phosphonic acid, and tris(2,2,2-trifluoroethyl) phosphate.

Preferably, in the method for producing an anode of this disclosure, at least one of the organic compounds each having a vinyl group is dissolved in the nonaqueous electrolyte solution, said at least one of the organic compounds each having a vinyl group having an aromatic ring including a nitrogen atom, and in the first step, temperature of the nonaqueous electrolyte solution is 50° C. to 70° C.

In the method for producing an anode of this disclosure, the organic compounds each having a vinyl group are preferably at least one organic compound selected from the group consisting of vinylimidazole, and vinylpyridine.

In the method for producing an anode of this disclosure, the anode preferably includes Li₄Ti₅O₁₂ as an anode active material.

The present application discloses a method for producing an aqueous lithium ion secondary battery, the method comprising: producing an anode according to the method for producing an anode of this disclosure: producing a cathode; producing an aqueous electrolyte solution; and storing the anode, the cathode, and the aqueous electrolyte solution in a battery case, as one means for solving the above described problem.

### Advantageous Effects

In the method for producing the anode of this disclosure, a film derived from a nonaqueous electrolyte solution is provided over the surface of the anode before the anode is applied to an aqueous lithium ion secondary battery. The film derived from the nonaqueous electrolyte solution has low electron conductivity. Applying the anode having the film of low electron conductivity over the surface thereof to the aqueous lithium ion secondary battery like the above can suppress giving and receiving electrons between the anode and the aqueous electrolyte solution, to suppress reductive decomposition of the aqueous electrolyte solution. As a result, an apparent potential window of the aqueous electrolyte solution on the reduction side in the aqueous lithium ion secondary battery expands, an anode active material, whose charge-discharge potential of lithium ions is baser can be employed, and the operating voltage of the battery can be improved.

### BRIEF DESCRIPTION OF DRAWINGS

FIG. 1 is an explanatory flowchart of a method for producing an anode for an aqueous lithium ion secondary battery S10;

FIG. 2 is an explanatory flowchart of a method for producing an aqueous lithium ion secondary battery S100:

FIG. 3 is an explanatory view of structure of an aqueous lithium ion secondary battery 1000;

FIG. 4 is an explanatory graph of the effect of Reference Example 1;

FIG. 5 is an explanatory graph of the effect of Reference Examples 2 to 6;

FIG. 6 is an explanatory graph of the effect of Reference Examples 7 to 10;

FIG. 7 is an explanatory graph of the effect of Reference Examples 11 and 12;

FIG. 8 is an explanatory graph of the effect of Reference Examples 13 to 15:

FIG. 9 shows the result of confirming discharge capacity of an aqueous lithium ion secondary battery of Comparative Example 2;

FIG. 10 shows the result of confirming discharge capacity of an aqueous lithium ion secondary battery of Example 1;

FIG. 11 shows the result of confirming discharge capacity of an aqueous lithium ion secondary battery of Example 2;

FIG. 12 shows the result of confirming discharge capacity of an aqueous lithium ion secondary battery of Example 3;

FIG. 13 shows the result of confirming discharge capacity of an aqueous lithium ion secondary battery of Example 4; and

FIG. 14 shows the result of confirming discharge capacity of an aqueous lithium ion secondary battery of Example 5.

### DETAILED DESCRIPTION OF EMBODIMENTS

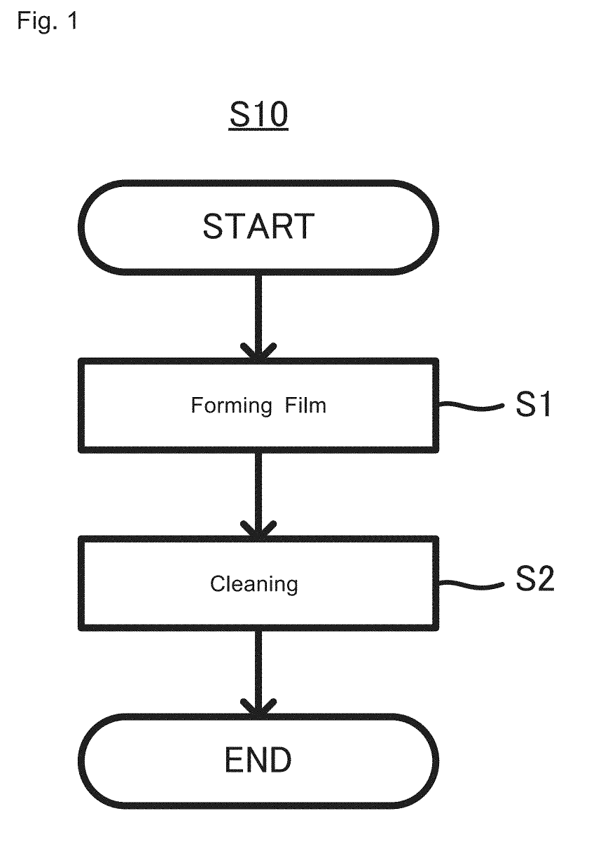

1. Method for Producing Anode for Aqueous Lithium Ion Secondary Battery FIG. 1 shows the flow of a method for producing an anode for an aqueous lithium ion secondary battery S10. As shown in FIG. 1, the producing method S10 includes a first step S1 of touching an anode that is electrochemically kept in a reduction or oxidation state to a nonaqueous electrolyte solution in which a lithium salt is dissolved, to form a film over a surface of the anode; and a second step S2 of cleaning the anode, over the surface of which the film is formed.

1.1. Nonaqueous Electrolyte Solution

The nonaqueous electrolyte solution used in the first step S1 contains nonaqueous solvent (organic solvent) as solvent in which the lithium salt is dissolved as an electrolyte. The nonaqueous electrolyte solution may contain (an) additive(s) in addition to the solvent and the lithium salt. The nonaqueous electrolyte solution has only to contain components that chemically change when electrochemically exposed to a reduction or oxidation state to form the film. Examples of the components to form the film include the nonaqueous solvent, and predetermined additives as described later.

1.1.1. Solvent

Known nonaqueous solvent employed to a nonaqueous electrolyte solution lithium ion secondary battery can be employed as the nonaqueous solvent (organic solvent) composing the nonaqueous electrolyte solution. Nonaqueous solvent that may decompose when electrochemically exposed to a reduction or oxidation state, to form the film is preferable. The nonaqueous solvent is preferably at least one selected from ethylene carbonate (EC), dimethyl carbonate (DMC), ethyl methyl carbonate (EMC), vinylene carbonate (VC), vinylethylene carbonate (VEC), fluoroethylene carbonate (FEC), diethyl carbonate (DEC), etc.

In the producing method S10, the film formed over the surface of the anode is not necessarily formed of components derived from the nonaqueous solvent, but may be formed of either components derived from (a) predetermined additive(s), or combination of components derived from the nonaqueous solvent and those derived from (a) predetermined additive(s). If the film derived from (an) additive(s) is formed in the first step S1, the nonaqueous solvent does not have to form the film when electrochemically exposed to a reduction or oxidation state. In view of forming a stabler film etc., nonaqueous solvent that may decompose when electrochemically exposed to a reduction or oxidation state, to form the film is preferable.

The nonaqueous electrolyte solution may contain solvent other than the nonaqueous solvent as well. Touching such a nonaqueous electrolyte solution to the anode that is electrochemically kept in a reduction or oxidation state even makes it possible to form the film over the surface of the anode without any problem.

1.1.2. Lithium Salt

In the first step S1, the nonaqueous electrolyte solution is touched to the anode that is kept in a reduction or oxidation state in order to chemically change components contained in the nonaqueous electrolyte solution. In other words, in the first step, voltage is applied to the nonaqueous electrolyte solution. A lithium salt mainly functions as solute for efficiently passing electricity through electrolyte solution. Dissolving the lithium salt in the nonaqueous electrolyte solution makes the ion conductivity of the nonaqueous electrolyte solution etc. high, to make it possible to efficiently form the film when voltage is applied. A known lithium salt that is employed to a nonaqueous electrolyte solution lithium ion secondary battery can be employed as the lithium salt dissolved in the nonaqueous electrolyte solution. The lithium salt is preferably at least one selected from LiPF₆, LiClO₄, LiBF₄, LiCF₃SO₃, lithium bis(trifluoromethanesulfonyl)imide (LiTFSI), lithium bis(fluorosulfonyl)imide (LiFSI), etc. The concentration of the lithium salt in the nonaqueous electrolyte solution is not specifically limited.

1.1.3. Additive

The nonaqueous electrolyte solution may contain (an) additive(s) in addition to the solvent and the lithium salt. Especially, (an) organic compound(s) other than the above described nonaqueous solvent which form(s) the film when exposed to a reduction or oxidation state is/are preferably contained.

The nonaqueous electrolyte solution preferably contains at least one organic compound selected from the group consisting of organic compounds each having a vinyl group, organosilicon compounds each including a carbon atom linked to a silicon atom that is next to the carbon atom, the carbon atom having a triple bond or a double bond, and organophosphorus compounds each including two or more oxygen atoms linked to a phosphorus atom that is next to the oxygen atoms. All these organic compounds may undergo polymerization reaction, to be the film when electrochemically exposed to a reduction or oxidation state. For example, in an organic compound having a vinyl group, the vinyl group receives an electron under reduction conditions, to initiate reduction polymerization, which may lead to formation of a stable film. An organosilicon compound as described above receives electrons under reduction conditions, to cleave the triple bond or the double bond of the carbon atom next to the silicon atom, to undergo polymerization, which may lead to formation of a stable film. Further, an organophosphorus compound as described above undergoes polymerization under oxidation conditions, to be polyphosphoric acid, which may lead to formation of a stable film. Whereby, applying the anode to an aqueous lithium ion secondary battery can more properly suppress giving and receiving electrons between an aqueous electrolyte solution and the anode, and can expand an apparent potential window of the aqueous electrolyte solution on the reduction side more.

Various organic compounds that may form the film according to the above described mechanism are considered. Among them, organic compounds each having a vinyl group are preferably at least one organic compound selected from the group consisting of vinylimidazole, vinylpyridine (may be any of 2-vinylpyridine and 4-vinylpyridine. Hereinafter the same will be applied), methyl methacrylate, styrene, and divinyl sulfone, and more preferably at least one organic compound selected from the group consisting of vinylimidazole, vinylpyridine, methyl methacrylate, and styrene; organosilicon compounds as described above are preferably at least one organic compound selected from the group consisting of 1,4-bis(trimethylsilyl)-1,3-butadiyne, trimethylsilylacetylene, trimethoxyphenylsilane, and triethoxyphenylsilane; and further organophosphorus compounds as described above are preferably at least one organic compound selected from the group consisting of (aminomethyl)phosphonic acid, and tris(2,2,2-trifluoroethyl) phosphate.

It is believed that the film can be also formed of an additive other than polymerizable organic compounds as described above. For example, it is believed that even if an organic compound having a sterically complex structure (steric hindrance) which makes polymerization reaction hard to progress is used, the film can be formed over the surface of the anode. This is because it is predicted that molecules of such an organic compound intertwine using steric hindrance, which may lead to formation of a thin film over the surface of the anode. In this point, it can be said that the above described organic compounds each having a vinyl group, organosilicon compounds, and organophosphorus compounds can bring about the desired effect without any specific limitation on their steric structures. In view of forming a stabler film, the above described organic compounds each having a vinyl group, organosilicon compounds, and organophosphorus compounds preferably form polymers when exposed to a reduction or oxidation state as described above.

The nonaqueous electrolyte solution may contain (an)other component(s) in addition to the solvent, electrolyte, and additive(s) as long as a predetermined film can be formed to solve the above described problem.

1.2. Anode

The anode that is touched to the nonaqueous electrolyte solution in the first step S1 usually has an anode current collector, and an anode active material layer including an anode active material, and touching the anode current collector. If the conductivity of the anode active material layer is enough high, the presence of the anode current collector is optional.

1.2.1. Anode Current Collector

Known conductive material that can be used as an anode current collector of an aqueous lithium ion secondary battery can be used as the anode current collector. Examples of such metal include metallic material containing at least one element selected from the group consisting of Cu, Ni, Al, V, Au, Pt, Mg, Fe, Ti, Co, Cr, Zn, Ge, and In. Or, the current collector may be formed of carbon material such as a sheet of graphite. The form of the anode current collector is not specifically restricted, and can be any form such as foil, mesh, and a porous form.

1.2.2. Anode Active Material Layer

The anode active material layer touches the anode current collector. For example, a surface of the anode current collector is coated with slurry containing the anode active material etc., and dried, to layer the anode active material layer over the surface of the anode current collector. Or, the anode active material etc. are dry-molded along with the anode current collector, which makes it possible to layer the anode active material layer over the surface of the anode current collector as well.

The anode active material layer includes the anode active material. The anode active material may be selected in view of a potential window of an aqueous electrolyte solution. Examples thereof include lithium-transition metal complex oxides; titanium oxide; metallic sulfides such as Mo₆S₈; elemental sulfur; LiTi₂(PO₄)₃; and NASICON. Or, the anode active material can be formed of carbon material such as artificial graphite, natural graphite, graphite filament, and amorphous carbon, according to a potential window of an aqueous electrolyte solution. Specifically, a lithium-transition metal complex oxide is preferably contained, and lithium titanate is more preferably contained. Among them, containing Li₄Ti₅O₁₂ (LTO) is especially preferable because good SEI (Solid Electrolyte Interphase) tends to be formed. As described above, LTO that is conventionally difficult to be used as an anode active material can be employed as well in the anode produced according to the producing method S10.

The shape of the anode active material is not specifically restricted. For example, a particulate shape is preferable. When the anode active material has a particulate shape, the primary particle size thereof is preferably 1 nm to 100 μm. The lower limit thereof is more preferably no less than 10 nm, further preferably no less than 50 nm, and especially preferably no less than 100 nm; and the upper limit thereof is more preferably no more than 30 μm, and further preferably no more than 10 μm. Primary particles of the anode active material one another may assemble to form a secondary particle. In this case, the secondary particle size is not specifically restricted, but is usually 0.5 μm to 100 μm. The lower limit thereof is preferably no less than 1 μm, and the upper limit thereof is preferably no more than 20 μm. The particle sizes of the anode active material within these ranges make it possible to obtain the anode active material layer further superior in ion conductivity and electron conductivity.

The amount of the anode active material included in the anode active material layer is not specifically limited. For example, on the basis of the whole of the anode active material layer (100 mass %), the content of the anode active material is preferably no less than 10 mass %, more preferably no less than 20 mass %, and further preferably no less than 40 mass %. The upper limit thereof is not specifically limited, but preferably no more than 99 mass %, more preferably no more than 95 mass %, and further preferably no more than 90 mass %. The content of the anode active material within this range makes it possible to obtain the anode active material layer further superior in ion conductivity and electron conductivity.

2.2.2. Optional Components

The anode active material layer preferably includes a conductive additive and binder in addition to the anode active material.

Any conductive additive used in an aqueous lithium ion secondary battery can be employed as the conductive additive. Specifically, a conductive additive containing carbon material selected from Ketjen black (KB), vapor grown carbon fiber (VGCF), acetylene black (AB), carbon nanotubes (CNT), and carbon nanofiber (CNF) is preferable. Or, metallic material that can bear an environment where the battery is used may be used. One conductive additive may be used individually, or two or more conductive additives may be mixed to be used as the conductive additive. Any shape such as powder and fiber can be employed as the shape of the conductive additive. The amount of the conductive additive included in the anode active material layer is not specifically restricted. For example, the content of the conductive additive is preferably no less than 10 mass %, more preferably no less than 30 mass %, and further preferably no less than 50 mass %, on the basis of the whole of the anode active material layer (100 mass %). The upper limit is not specifically restricted, but is preferably no more than 90 mass %, more preferably no more than 70 mass %, and further preferably no more than 50 mass %. The content of the conductive additive within this range makes it possible to obtain the anode active material layer further superior in ion conductivity and electron conductivity.

Any binder used in an aqueous lithium ion secondary battery can be employed as the binder. Examples thereof include styrene-butadiene rubber (SBR), carboxymethyl cellulose (CMC), acrylonitrile-butadiene rubber (ABR), butadiene rubber (BR), polyvinylidene fluoride (PVDF), and polytetrafluoroethylene (PTFE). One binder may be used individually, or two or more binders may be mixed to be used. The amount of the binder included in the anode active material layer is not specifically restricted. For example, the content of the binder is preferably no less than 1 mass %, more preferably no less than 3 mass %, and further preferably no less than 5 mass/%, on the basis of the whole of the anode active material layer (100 mass %). The upper limit is not specifically restricted, but is preferably no more than 90 mass %, more preferably no more than 70 mass %, and further preferably no more than 50 mass %. The content of the binder within this range makes it possible to properly bind the anode active material etc., and to obtain the anode active material layer further superior in ion conductivity and electron conductivity.

The thickness of the anode active material layer is not specifically restricted, but, for example, is preferably 0.1 μm to 1 mm, and more preferably 1 μm to 100 μm.

1.3. Touching in Reduction or Oxidation State

In the first step S1, the anode of the above described structure is touched to the nonaqueous electrolyte solution while being kept in a reduction or oxidation state. That is, when touched to the nonaqueous electrolyte solution, the anode is kept at a predetermined reduction or oxidation potential. The potential of the anode may be a potential that makes it possible to chemically change components contained in the nonaqueous electrolyte solution, to form the film. For example, when a reduced film is formed, the potential of the anode is preferably 0.01 V (vs. Li/Li+) to 1 V (vs. Li/Li+). The lower limit is more preferably no less than 0.1 V, and the upper limit is more preferably no more than 0.8 V. Too low potential leads to growth of lithium metal while too high potential may lead to deteriorated formation of the film. On the other hand, when an oxide film is formed, the potential of the anode is preferably 4 V (vs. Li/Li+) to 5 V (vs. Li/Li+). The lower limit is more preferably no less than 4.2 V, and the upper limit is more preferably no more than 4.8 V. Keeping the anode at such potentials makes it possible to more efficiently form the film over the surface of the anode.

The manner of touching the nonaqueous electrolyte solution to the anode is not specifically limited. For example, the anode is preferably immersed in the nonaqueous electrolyte solution. In this case, a counter electrode is immersed in the electrolyte solution together with the anode, and the immersed anode and the counter electrode are electrically connected, to apply voltage to the nonaqueous electrolyte solution. It is also possible to form a nonaqueous lithium ion secondary battery using the anode, the counter electrode, and the nonaqueous electrolyte solution, charge and/or discharge this lithium ion secondary battery, and keep the anode at a predetermined reduction or oxidation potential. Whereby, the surface of the anode is kept in a reduction or oxidation state, and components contained in the nonaqueous electrolyte solution chemically change over the surface of the anode, to form the film.

In this case, lithium metal; or LiMn₂O₄, LiFePO₄, a lithium composite oxide containing Ni, Mn, and Co, or the like which is known as a cathode active material of a nonaqueous lithium ion secondary battery can be used as the counter electrode. The current in charge and/or discharge is preferably 0.01 mA/cm² to 10 mA/cm². If the current is small, it takes a lot of time to form the film. A too large current may lead to deteriorated uniformity of the film.

The temperature of the nonaqueous electrolyte solution while the nonaqueous electrolyte solution and the anode are touched, to form the film is not specifically limited. The temperature has only to be temperature so that the nonaqueous electrolyte solution can keep in the form of liquid. For example, the temperature of the nonaqueous electrolyte solution is preferably 10° C. to 70° C.

According to the new findings of the inventors of the present application, when an organic compound having a vinyl group is dissolved in the nonaqueous electrolyte solution, the temperature of the nonaqueous electrolyte solution at 50° C. to 70° C. in the first step makes it possible to form a stabler film over the surface of the anode if this organic compound has an aromatic ring including a nitrogen atom. In this case, a stable film is formed over the surface of the anode in either case where the anode is in a reduction state or in an oxidation state. Such a high temperature of the nonaqueous electrolyte solution as 50° C. to 70° C. can lead to a thicker film. Whereby, when the anode is applied to an aqueous lithium ion secondary battery, giving and receiving electrons between an aqueous electrolyte solution and the anode can be properly suppressed, and an apparent potential window of the aqueous electrolyte solution on the reduction side can be expanded more. In view of this, this organic compound having a vinyl group is preferably at least one organic compound selected from the group consisting of vinylimidazole, and vinylpyridine.

1.4. Film

The film formed over the surface of the anode in the first step is chemically changed components contained in the nonaqueous electrolyte solution as described above. The thickness of the film is not specifically limited, but for example, is preferably 1 nm to 10 μm. The thickness of the film can be properly adjusted according to the time of touching the nonaqueous electrolyte solution and the anode, the reduction or oxidation state of the anode, etc. in the first step. The composition of the film is not specifically limited as well. If the film is formed of components derived from the nonaqueous solvent (components generated due to decomposition of the nonaqueous solvent), it is believed that the film contains H, C, and O as constituent elements. When the film is formed by the nonaqueous electrolyte solution, it is believed that components derived from the lithium salt contained in the nonaqueous electrolyte solution is also taken into the film. In contrast, if the film is formed of components derived from (a) predetermined additive(s) as described above, it is believed that the film contains a polymer whose structural unit is a predetermined organic compound as described above. The film formed by chemically changed components contained in the nonaqueous electrolyte solution has lower electron conductivity than the anode active material included in the anode. That is, the film functions as a protective film to block giving and receiving electrons between the anode and an aqueous electrolyte solution when the anode is applied to an aqueous lithium ion secondary battery.

A certain effect of the film is expectable if the film is formed over at least part of the surface of the anode. In view of bringing about a more significant effect, the film is preferably formed all over the surface of the anode which touches an aqueous electrolyte solution when the anode is applied to an aqueous lithium ion secondary battery. In other words, in the first step, the nonaqueous electrolyte solution preferably touches all over the surface of the anode which touches an aqueous electrolyte solution when the anode is applied to an aqueous lithium ion secondary battery.

1.5. Cleaning

In the producing method S10, the anode, over the surface of which the film is formed in the first step S1, is cleaned in the second step. In the second step S2, the anode is preferably cleaned with nonaqueous solvent (organic solvent). For example, cleaning up the surface of the anode with the nonaqueous solvent that may form the nonaqueous electrolyte solution can dissolve to remove the lithium salt derived from the nonaqueous electrolyte solution etc. which remain over the surface of the anode. The cleaning time and frequency are not specifically limited. As described above, the film formed over the surface of the anode is an electrochemically formed stable film. Thus, the film is not easily washed away in the second step. That is, in the second step, unnecessary residues (lithium salt etc.) can be properly removed from the surface of the anode while leaving the film over the surface of the anode. After cleaned, the anode is properly dried. The anode may be either air-dried or machine-dried.

As described above, according to the producing method S10, the anode, over the surface of which the film of a low electron conductivity is formed, can be produced. When the anode produced according to the producing method S10 is applied to an aqueous lithium ion secondary battery, giving and receiving electrons between the anode and an aqueous electrolyte solution can be suppressed, which makes it possible to suppress reductive decomposition of the aqueous electrolyte solution. As a result, a potential window of the aqueous electrolyte solution on the reduction side in the aqueous lithium ion secondary battery apparently expands, an anode active material whose charge-discharge potential of lithium is baser (for example, the above described LTO) can be employed, and the operating voltage of the battery can be improved.

2. Method for Producing Aqueous Lithium Ion Secondary Battery

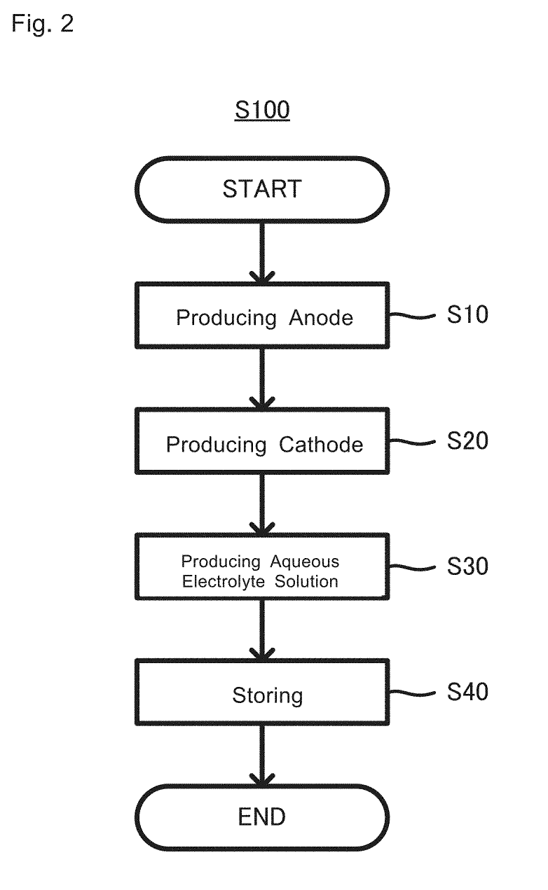

FIG. 2 is the flowchart of a method for producing an aqueous lithium ion secondary battery S100. As shown in FIG. 2, the producing method S100 includes the steps of producing an anode according to the producing method S10, producing a cathode S20, producing an aqueous electrolyte solution S30, and storing the produced anode, cathode, and aqueous electrolyte solution in a battery case S40. The order of producing the anode, the cathode and the aqueous electrolyte solution is not specifically limited.

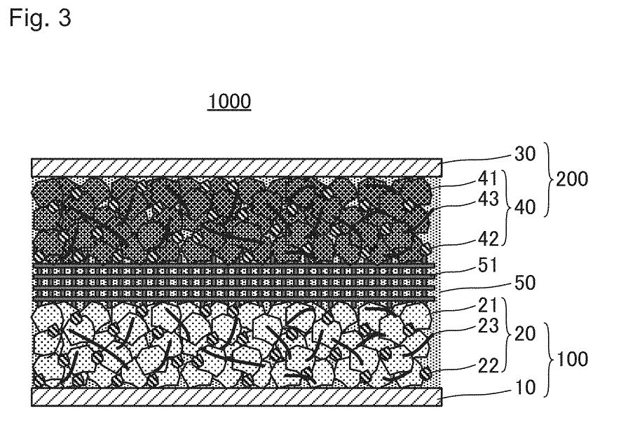

FIG. 3 schematically shows the structure of an aqueous lithium ion secondary battery 1000 produced according to the producing method S100. Hereinafter, the producing method S100 will be described employing the reference numerals shown in FIG. 3.

2.1. Producing Anode

In the producing method S100, an anode 100 is produced according to the producing method S10, which was described already. An anode current collector 10, an anode active material layer 20, an anode active material 21, a conductive additive 22, and a binder 23 which form the anode 100 are as described already. The anode 100 has a film (not shown) over its surface. For example, the anode 100 having a film over its surface can be produced by carrying out the first step S1 and the second step S2 after the anode active material layer 20 is layered over a surface of the anode current collector 10.

2.2. Producing Cathode

The cathode 200 includes a cathode current collector 30, and a cathode active material layer 40 that includes a cathode active material 41, and touches the cathode current collector 30. The step S20 of producing the cathode 200 may be the same as a known step. For example, the cathode active material 41 etc. to form the cathode active material layer 40 is dispersed in solvent, to obtain a cathode mixture paste (slurry). Water or any organic solvent can be used as the solvent used in this case without specific restrictions. A surface of the cathode current collector 30 is coated with the cathode mixture paste (slurry) using a doctor blade or the like, and thereafter dried, to form the cathode active material layer 40 over the surface of the cathode current collector 30, to be the cathode 200. Electrostatic spray deposition, dip coating, spray coating, or the like can be employed as well, as the coating method other than a doctor blade method. Or, the cathode active material 41 etc. are dry-molded along with the cathode current collector 30, which makes it possible to layer the cathode active material layer 40 over the surface of the cathode current collector 30 as well.

2.2.1. Cathode Current Collector

Known metal that can be used as a cathode current collector of an aqueous lithium ion secondary battery can be used as the cathode current collector 30. Examples thereof include metallic material containing at least one element selected from the group consisting of Cu. Ni, Al, V, Au, Pt, Mg, Fe, Ti, Co, Cr, Zn, Ge, and In. Alternatively, the current collector may be formed of carbon material such as a sheet of graphite. The form of the cathode current collector 30 is not specifically restricted, and can be any form such as foil, mesh, and a porous form.

2.2.2. Cathode Active Material Layer

The cathode active material layer 40 includes the cathode active material 41. The cathode active material layer 40 may include a conductive additive 42, and a binder 43, in addition to the cathode active material 41.

Any cathode active material for an aqueous lithium ion secondary battery can be employed as the cathode active material 41. Needless to say, the cathode active material 41 has a potential higher than that of the anode active material 21, and is properly selected in view of a potential window of an aqueous electrolyte solution 50 which will be described later. For example, a Li element is preferably contained. Specifically, an oxide, or a polyanion which contains a Li element is preferable, which is more specifically lithium cobaltate (LiCoO₂); lithium nickelate (LiNiO₂); lithium manganate (LiMn₂O₄); LiN_{1/3}Mn_{1/3}Co_{1/3}O₂; a different kind element substituent Li—Mn spinel represented by Li₁₊ₓMn_{2-x-y}MyO₄ (M is at least one selected from Al, Mg, Co, Fe, Ni. and Zn); lithium titanate that shows a nobler charge-discharge potential compared with that of the anode active material (LiₓTiO_{y}); a lithium metal phosphate (LiMPO₄. M is at least one selected from Fe, Mn, Co, and Ni); or the like. Specifically, a cathode active material containing a Mn element in addition to a Li element is preferable, and a cathode active material having a spinel structure such as LiMn₂O₄, and Li₁₊ₓMn_{2-x-y}Ni_{y}O₄ is more preferable. Since the oxidation potential of the potential window of the aqueous electrolyte solution 50 may be approximately no less than 5.0 V (vs. Li/Li+), a cathode active material of a high potential which contains a Mn element in addition to a Li element can be used as well. One cathode active material may be used individually, or two or more cathode active materials may be mixed to be used as the cathode active material 41.

The shape of the cathode active material 41 is not specifically restricted. A preferred example thereof is a particulate shape. When the cathode active material 41 has a particulate shape, the primary particle size thereof is preferably 1 nm to 100 pnm. The lower limit thereof is more preferably no less than 5 nm, further preferably no less than 10 nm, and especially preferably no less than 50 nm; and the upper limit thereof is more preferably no more than 30 μm, and further preferably no more than 10 μm. Primary particles of the cathode active material 41 one another may assemble to form a secondary particle. In this case, the secondary particle size is not specifically restricted, but is usually 0.5 μm to 50 μm. The lower limit thereof is preferably no less than 1 μm, and the upper limit thereof is preferably no more than 20 μm. The particle sizes of the cathode active material 41 within these ranges make it possible to obtain the cathode active material layer 40 further superior in ion conductivity and electron conductivity.

The amount of the cathode active material 41 included in the cathode active material layer 40 is not specifically restricted. For example, on the basis of the whole of the cathode active material layer 40 (100 mass %), the content of the cathode active material 41 is preferably no less than 20 mass %, more preferably no less than 40 mass %, further preferably no less than 60 mass %, and especially preferably no less than 70 mass %. The upper limit is not specifically restricted, but is preferably no more than 99 mass %, more preferably no more than 97 mass %, and further preferably no more than 95 mass %. The content of the cathode active material 41 within this range makes it possible to obtain the cathode active material layer 40 further superior in ion conductivity and electron conductivity.

The cathode active material layer 40 preferably includes the conductive additive 42, and the binder 43, in addition to the cathode active material 41. The conductive additive 42 and the binder 43 are not specifically limited, and for example, examples of the conductive additive 22 and the binder 23 as described above can be properly selected to be used. The amount of the conductive additive 42 included in the cathode active material layer 40 is not specifically restricted. For example, the content of the conductive additive 42 is preferably no less than 0.1 mass %, more preferably no less than 0.5 mass %, and further preferably no less than 1 mass %, on the basis of the whole of the cathode active material layer 40 (100 mass %). The upper limit is not specifically restricted, but is preferably no more than 50 mass %, more preferably no more than 30 mass %, and further preferably no more than 10 mass %. The content of the conductive additive 42 within this range makes it possible to obtain the cathode active material layer 40 further superior in ion conductivity and electron conductivity. The amount of the binder 43 included in the cathode active material layer 40 is not specifically restricted. For example, the content of the binder 43 is preferably no less than 0.1 mass %, more preferably no less than 0.5 mass %, and further preferably no less than 1 mass %, on the basis of the whole of the cathode active material layer 40 (100 mass %). The upper limit is not specifically restricted, but is preferably no more than 50 mass %, more preferably no more than 30 mass %, and further preferably no more than 10 mass %. The content of the binder 43 within this range makes it possible to properly bind the cathode active material 41 etc., and to obtain the cathode active material layer 40 further superior in ion conductivity and electron conductivity.

The thickness of the cathode active material layer 40 is not specifically restricted, but for example, is preferably 0.1 μm to 1 mm, and more preferably 1 μm to 100 μm.

2.3. Producing Aqueous Electrolyte Solution

The aqueous electrolyte solution can be produced by mixing solvent containing at least water, and an electrolyte.

2.3.1. Solvent

The solvent contains water as the main component. That is, no less than 50 mol %, preferably no less than 70 mol %, and more preferably no less than 90 mol % of the solvent that forms the electrolyte solution (liquid components) is water, on the basis of the total amount of the solvent (100 mol %). In contrast, the upper limit of the proportion of water in the solvent is not specifically restricted.

While containing water as the main component, the solvent may further contain solvent other than water in view of, for example, forming SEI over a surface of active material. Examples of the solvent except water include at least one nonaqueous solvent selected from ethers, carbonates, nitriles, alcohols, ketones, amines, amides, sulfur compounds, and hydrocarbons. Preferably no more than 50 mol %, more preferably no more than 30 mol %, and further preferably no more than 10 mol % of the solvent that forms the electrolyte solution (liquid components) is the solvent other than water, on the basis of the total amount of the solvent (100 mol %).

2.3.2. Electrolyte

The aqueous electrolyte solution 50 contains an electrolyte. Electrolytes for aqueous electrolyte solutions themselves are publicly known. For example, the electrolyte preferably contains lithium bis(trifluoromethanesulfonyl)imide (LiTFSI). The electrolyte more preferably contains LiTFSI as the main component. That is, on the basis of the total amount of the electrolyte contained (dissolving) in the electrolyte solution (100 mol %), preferably no less than 50 mol %, more preferably no less than 70 mol %, and further preferably no less than 90 mol % of the electrolyte is LiTFSI.

The aqueous electrolyte solution 50 preferably contains no less than 1 mol of LiTFSI per kilogram of the above described water. The content thereof is more preferably no less than 5 mol/kg, further preferably no less than 7.5 mol/kg, and especially preferably no less than 10 mol/kg. The upper limit is not specifically restricted, and for example, is preferably no more than 25 mol/kg. As the concentration of LiTFSI is high in the aqueous electrolyte solution 50, the potential window of the aqueous electrolyte solution 50 on the reduction side tends to expand.

Specifically, the aqueous electrolyte solution 50 preferably contains 7.5 mol to 21 mol of LiTFSI per kilogram of the above described water. According to the findings of the inventors of the present application, the concentration of LiTFSI within such a range brings about better balanced effect of improving withstandingness against voltage for suppressing decomposition of the electrolyte solution, and of improving the ion conductivity of the electrolyte solution.

The aqueous electrolyte solution 50 may further contain (an) electrolyte(s) other than LiTFSI. As (an) electrolyte(s) other than LiTFSI, (an) imide electrolyte(s) such as lithium bis(fluorosulfonyl)imide, LiPF₆, LiBF₄, Li₂SO₄, LiNO₃, etc. may be contained. The electrolyte(s) other than LiTFSI is/are preferably no more than 50 mol %, more preferably no more than 30 mol %, and further preferably no more than 10 mol % of the electrolyte contained (dissolving) in the electrolyte solution, on the basis of the total amount of the electrolyte (100 mol %).

2.3.3. Optional Components

The aqueous electrolyte solution 50 may contain (an)other component(s) in addition to the solvent and electrolyte. For example, alkali metals other than lithium, alkaline earth metals, etc. as cations can be added as the other components. Further, lithium hydroxide etc. may be contained for adjusting pH of the aqueous electrolyte solution 50.

pH of the aqueous electrolyte solution 50 is not specifically restricted. There are general tendencies for a potential window on the oxidation side to expand as pH of an aqueous electrolyte solution is low, while for that on the reduction side to expand as pH thereof is high. Here, according to the new findings of the inventors of the present application, as the concentration of LiTFSI in the aqueous electrolyte solution 50 is high, pH of the aqueous electrolyte solution 50 is low. Nevertheless, according to the new findings of the inventors, the potential window on the reduction side can be sufficiently expanded even if a high concentration of LiTFSI is contained in the aqueous electrolyte solution 50. For example, even if pH of the aqueous electrolyte solution 50 is as low as 3, the potential window on the reduction side can be sufficiently expanded. The upper limit of pH is not specifically restricted, but in view of keeping the potential window on the oxidation side high, pH is preferably no more than 11. In summary, pH of the aqueous electrolyte solution 50 is preferably 3 to 11. The lower limit of pH is more preferably no less than 6, and the upper limit thereof is more preferably no more than 8.

2.3.4. Separator

An electrolyte solution exists inside an anode active material layer, inside a cathode active material layer, and between the anode and cathode active material layers in a lithium ion secondary battery of the electrolyte solution system, which secures lithium ion conductivity between the anode and cathode active material layers. This manner is also employed for the battery 1000. Specifically, in the battery 1000, a separator 51 is provided between the anode active material layer 20 and the cathode active material layer 40. All the separator 51, the anode active material layer 20, and the cathode active material layer 40 are immersed in the aqueous electrolyte solution 50. The aqueous electrolyte solution 50 penetrates inside the anode active material layer 20 and the cathode active material layer 40, and touches the anode current collector 10 and the cathode current collector 30.

A separator used in a conventional aqueous electrolyte solution battery (NiMH, Zn-Air battery, etc.) is preferably employed for the separator 51. For example, a hydrophilic separator such as nonwoven fabric made of cellulose can be preferably used. The thickness of the separator 51 is not specifically restricted. For example, a separator of 5 μm to 1 mm in thickness can be used.

2.5. Storing in Battery Case

The produced anode 100, cathode 200, and aqueous electrolyte solution 50 are stored in a battery case, to be the aqueous lithium ion secondary battery 1000. For example, the separator 51 is sandwiched between the anode 100 and the cathode 200, to obtain a stack including the anode current collector 10, the anode active material layer 20, the separator 51, the cathode active material layer 40, and the cathode current collector 30 in this order. The stack is equipped with other members such as terminals if necessary. The stack is stored in a battery case, and the battery case is filled with the aqueous electrolyte solution 50. The battery case which the stack is stored in and is filled with the electrolyte solution is sealed up such that the stack is immersed in the aqueous electrolyte solution 50, which makes it possible to obtain the aqueous lithium ion secondary battery 1000.

As described above, in the aqueous lithium ion secondary battery 1000 produced according to the producing method S100, the film of a low electron conductivity is formed over the surface of the anode, and giving and receiving electrons between the anode 100 and the aqueous electrolyte solution 50 can be suppressed, which makes it possible to suppress reductive decomposition of the aqueous electrolyte solution 50. As a result, the potential window of the aqueous electrolyte solution 50 on the reduction side in the aqueous lithium ion secondary battery 1000 apparently expands, the anode active material 21, whose charge-discharge potential of lithium is baser (for example, the above described LTO), can be employed, and the operating voltage of the battery can be improved.

3. Addition

The anode 100 produced according to the producing method S10 of the present disclosure, and the battery 1000 produced according to the producing method S100 of the present disclosure are new as products. That is, the present application can be also said to disclose products of an anode for an aqueous lithium ion secondary battery, and an aqueous lithium ion secondary battery, which are, for example, as described in the following (1) to (4). Preferred materials for composing the members are same as those described already, and thus detailed description thereof is omitted here.

(1) An anode for an aqueous lithium ion secondary battery, the anode having a film over a surface thereof, wherein the film comprises components derived from a nonaqueous solvent.

(2) The anode according to (1), wherein the film is obtained by decomposition of a nonaqueous electrolyte solution containing the nonaqueous solvent under reduction or oxidation conditions.

(3) An anode for an aqueous lithium ion secondary battery, the anode having a film over a surface thereof, wherein the film comprises a polymer of at least one organic compound selected from the group consisting of organic compounds each having a vinyl group, organosilicon compounds each including a carbon atom linked to a silicon atom that is next to the carbon atom, the carbon atom having a triple bond or a double bond, and organophosphorus compounds each including two or more oxygen atoms linked to a phosphorus atom that is next to the oxygen atoms.

(4) An aqueous lithium ion secondary battery that includes an anode, a cathode, and an aqueous electrolyte solution, wherein the anode is the anode according to any of (1) to (3).

### EXAMPLES

1. Preliminary Experiment

The effect of forming a film over a surface of an anode was confirmed by the following preparatory experiment.

### Reference Example 1

(Producing Anode)

A nonaqueous lithium ion secondary battery was made using a sheet of graphite (φ: 16 mm) as an anode, a nonaqueous electrolyte solution obtained by dissolving 1 M of LiPF₆ in nonaqueous solvent (EM:DMC:EMC=3:4:3), and lithium metal as a counter electrode. The made battery was discharged to 0.5 V at 25° C. at 0.1 mA, kept at 0.5 V (vs. Li/Li+) for 10 hours, and thereafter charged to 3 V at 0.1 mA, to form a film over the sheet of graphite. The battery was disassembled to take out the anode, and a surface of the anode was cleaned up with EMC to remove residues, to obtain the anode, the surface of which the film was formed.

(Producing Aqueous Lithium Ion Battery)

An aqueous lithium ion battery was produced using the anode, the surface of which the film was formed as described above, a SUS plate where gold was deposited as a counter electrode, a Ag/AgCl electrode as a reference electrode, and an aqueous electrolyte solution obtained by dissolving 21 mol of LiTFSI per 1 kg of water.

(Evaluation of Potential Window)

In the produced aqueous lithium ion battery, a working electrode (qp: 13 mm) was scanned at 10 mV/s within the range of 0.44 V to 3.244 V (vs. Li/Li+) in terms of the Ag/AgCl electrode which was the reference electrode. Voltage when 0.1 mA of a reduction current flowed was determined to be a potential window of the aqueous electrolyte solution on the reduction side.

### Reference Examples 2 to 15 and Comparative Example 1

Aqueous lithium ion batteries of Reference Examples 2 to 15 were produced in the same manner as Reference Example 1 except that predetermined additives of predetermined amounts were added to the nonaqueous electrolyte solutions under conditions shown in the following Table 1, and that films were formed at predetermined film forming potentials and temperatures. An aqueous lithium ion battery of Comparative Example 1 was also produced using a sheet of graphite as it was as an anode without forming a film. Potential windows of the produced aqueous lithium ion batteries were evaluated in the same manner as Reference Example 1. In the following Table 1, the amount of addition (wt %) was on the basis of the nonaqueous electrolyte solution before the additive was added (100 wt %). That is, 1 or 10 parts by weight of the additive were added to 100 parts by weight of the nonaqueous electrolyte solution.

TABLE 1

| | Additive to Nonaqueous Electrolyte | Amount of | Film Forming | Film Forming |
|---|---|---|---|---|
| | Solution | Addition | Potential | Temp. |
| Ref. Ex. 1 | None | — | 0.5 V | 25° C. |
| Ref. Ex. 2 | 1-vinylimidazole | 1 wt % | 0.5 V | 25° C. |
| Ref. Ex. 3 | methyl methacrylate | 10 wt % | 0.5 V | 25° C. |
| Ref. Ex. 4 | styrene | 10 wt % | 0.5 V | 25° C. |
| Ref. Ex. 5 | 2-vinylpyridine | 10 wt % | 0.5 V | 25° C. |
| Ref. Ex. 6 | 4-vinylpyridine | 10 wt % | 0.5 V | 25° C. |
| Ref. Ex. 7 | 1,4-bis(trimethylsilyl)-1,3-butadiyne | 10 wt % | 0.5 V | 25° C. |
| Ref. Ex. 8 | trimethylsilylacetylene | 10 wt % | 0.5 V | 25° C. |
| Ref. Ex. 9 | trimethoxyphenylsilane | 10 wt % | 0.5 V | 25° C. |
| Ref. Ex. 10 | triethoxyphenylsilane | 10 wt % | 0.5 V | 25° C. |
| Ref. Ex. 11 | (aminomethyl)phosphonic acid | 10 wt % | 4.5 V | 25° C. |
| Ref. Ex. 12 | tris(2,2,2-trifluoroethyl) phosphate | 10 wt % | 4.5 V | 25° C. |
| Ref. Ex. 13 | 1-vinylimidazole | 10 wt % | 4.5 V | 60° C. |
| Ref. Ex. 14 | 2-vinylpyridine | 10 wt % | 0.5 V | 60° C. |
| Ref. Ex. 15 | 4-vinylpyridine | 10 wt % | 4.5 V | 60° C. |

| | |
|---|---|
| Comp. Ex. 1 | No Film Formed |

The following are chemical formulae of the additives.

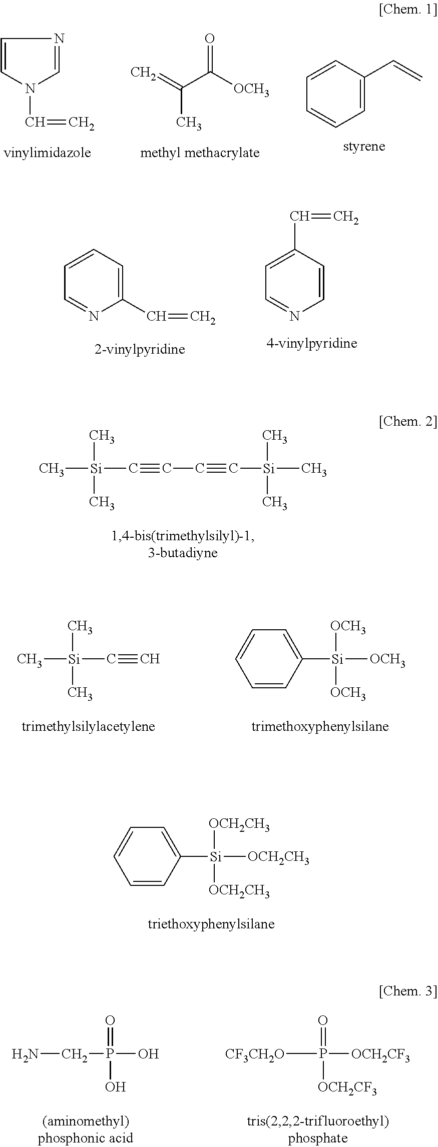

(Results of Evaluation)

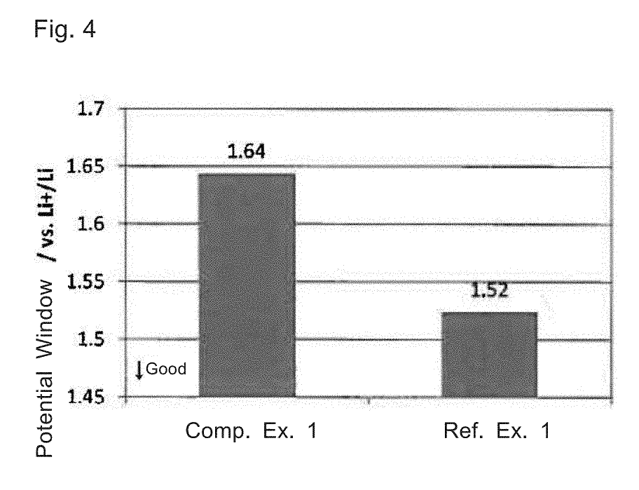

As shown in FIG. 4, while the potential window of the aqueous electrolyte solution on the reduction side was 1.64 V in the battery of Comparative Example 1, that expanded to 1.52 V in the battery of Reference Example 1.

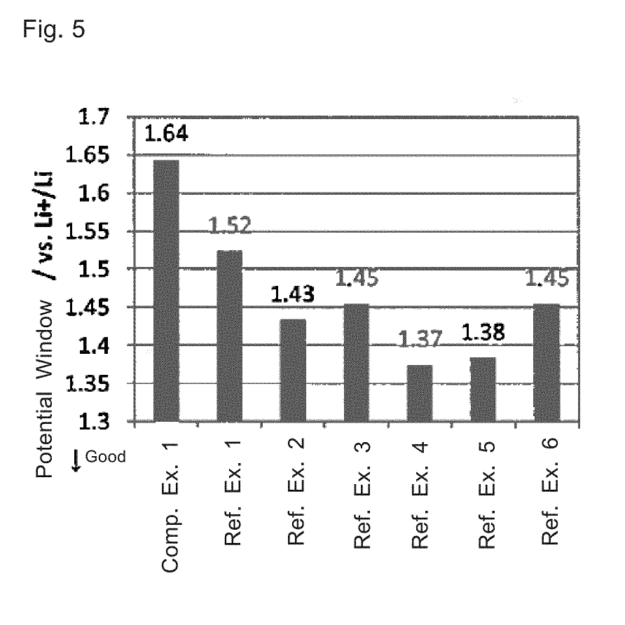

As shown in FIG. 5, the potential windows of the aqueous electrolyte solutions on the reduction side were able to further expand to no more than 1.45 V in the batteries of Reference Examples 2 to 6 wherein organic compounds each having a vinyl group were added to the nonaqueous electrolyte solutions when the films were formed, compared to the batteries of Comparative Example 1 and Reference Example 1.

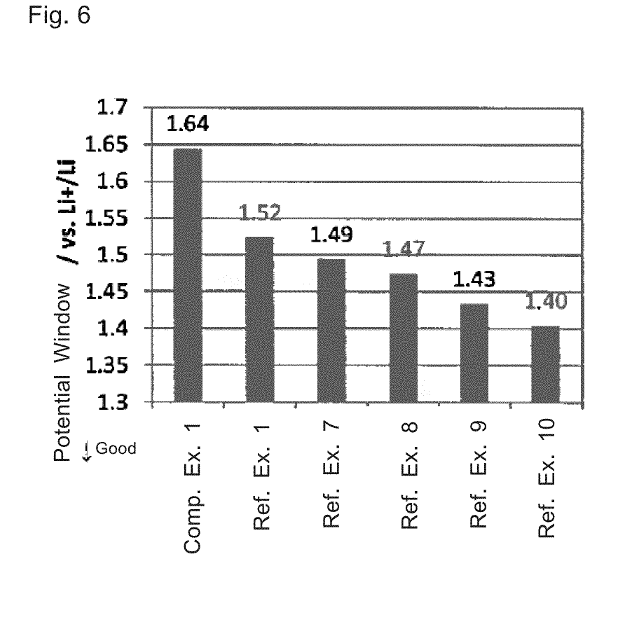

As shown in FIG. 6, the potential windows of the aqueous electrolyte solutions on the reduction side were able to further expand to no more than 1.49 V in the batteries of Reference Examples 7 to 10 wherein predetermined organosilicon compounds were added to the nonaqueous electrolyte solutions when the films were formed, compared to the batteries of Comparative Example 1 and Reference Example 1.

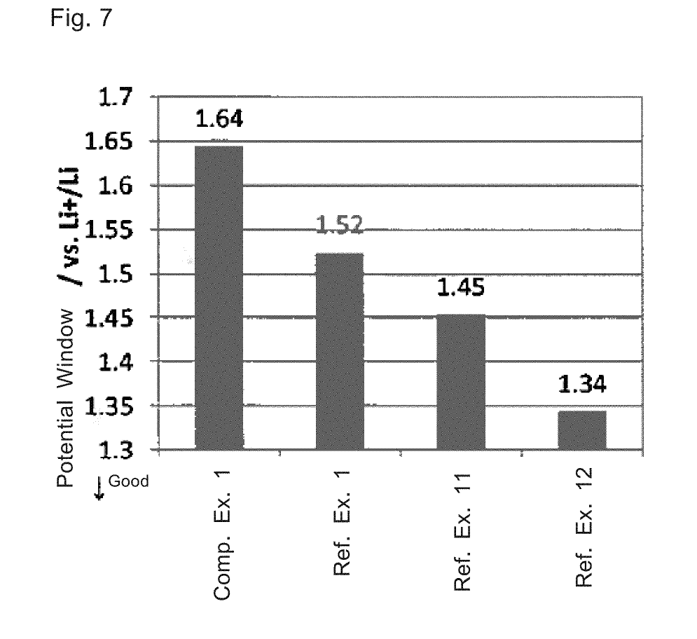

As shown in FIG. 7, the potential windows of the aqueous electrolyte solutions on the reduction side were able to further expand to no more than 1.45 V in the batteries of Reference Examples 11 and 12 wherein predetermined organophosphorus compounds were added to the nonaqueous electrolyte solutions when the films were formed, compared to the batteries of Comparative Example 1 and Reference Example 1.

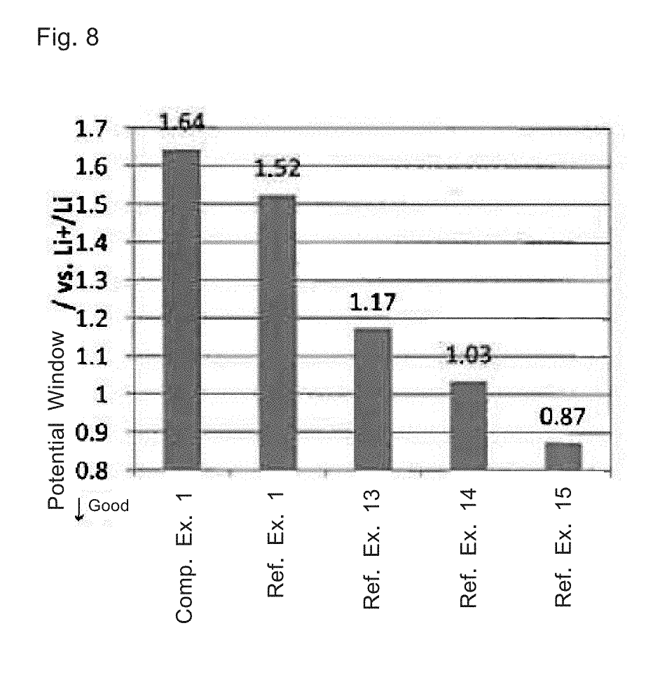

As shown in FIG. 8, the potential windows of the aqueous electrolyte solutions on the reduction side were able to largely expand to no more than 1.17 V in the batteries of Reference Examples 13 to 15 wherein organic compounds each having a vinyl group, and an aromatic ring including a nitrogen atom were added to the nonaqueous electrolyte solutions when the films were formed, and the film forming temperatures were high, compared to the batteries of Comparative Example 1 and Reference Example 1.

2. Evaluation of Charge and Discharge

Based on the results of the preliminary experiment, a film forming process was carried out on an anode actually having an anode active material, and the effect thereof was confirmed.

### Example 1

(Producing Anode)

An anode current collector (the above described sheet of graphite) was coated with an anode slurry containing an anode active material (LTO), a conductive additive (carbon black), and a binder (PVdF) so that the mass ratio thereof was 85:10:5, and dried, to obtain an anode. A film was formed for the obtained anode under the same conditions as Reference Example 1, to produce the anode having the film over its surface.

(Producing Cathode)

A cathode current collector (Ti foil) was coated with a cathode slurry containing a cathode active material (LiNi_{1/3}Mn_{1/3}Co_{1/3}O₂), a conductive additive (carbon black), and a binder (PVdF) so that the mass ratio thereof was 85:10:15, and dried, to produce a cathode.

(Producing Aqueous Lithium Ion Secondary Battery)

An aqueous lithium ion secondary battery was produced using the anode, the surface of which the film was formed as described above, the cathode produced as described above, a Ag/AgCl electrode as a reference electrode, and an aqueous electrolyte solution obtained by dissolving 21 mol of LiTFSI per 1 kg of water.

(Conditions of Charge and Discharge Testing)

The produced aqueous lithium ion secondary battery was charged and discharged under the following conditions, to measure discharge capacity.

Charge/discharge current: 0.1 mA

Charge/discharge end current: 0.01 mA

End time: 10 h

### Example 2

An aqueous lithium ion secondary battery was produced, and charged and discharged, to measure discharge capacity in the same manner as Example 1 except that a film was formed for the anode under the same conditions as Reference Example 5, to produce the anode having the film over its surface.

### Example 31

An aqueous lithium ion secondary battery was produced, and charged and discharged, to measure discharge capacity in the same manner as Example 1 except that a film was formed for the anode under the same conditions as Reference Example 8, to produce the anode having the film over its surface.

### Example 4

An aqueous lithium ion secondary battery was produced, and charged and discharged, to measure discharge capacity in the same manner as Example 1 except that a film was formed for the anode under the same conditions as Reference Example 11, to produce the anode having the film over its surface.

### Example 5

An aqueous lithium ion secondary battery was produced, and charged and discharged, to measure discharge capacity in the same manner as Example 1 except that a film was formed for the anode under the same conditions as Reference Example 15, to produce the anode having the film over its surface.

### Comparative Example 2

An aqueous lithium ion secondary battery was produced in the same manner as Example 1, and charge and discharge testing was carried out in the same manner as Example 1 except that the film forming process was not carried out when the anode was produced.

(Results of Evaluation)

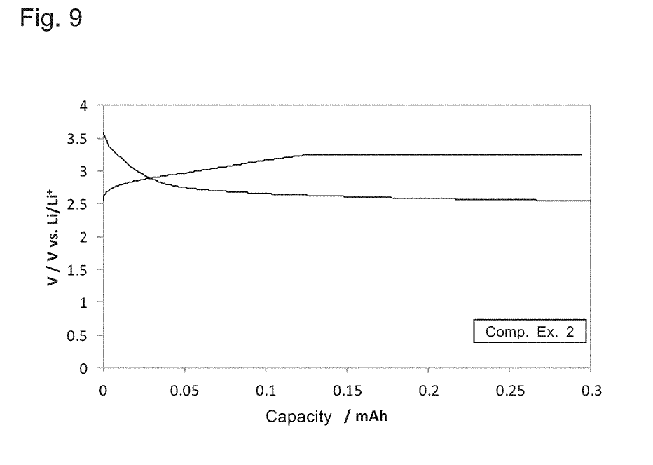

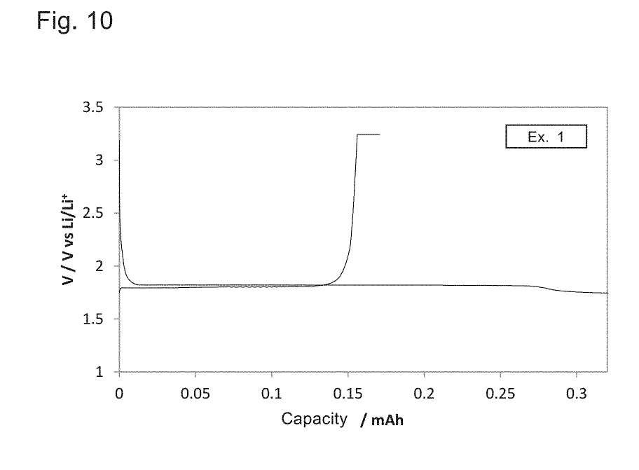

FIG. 9 shows the result of charge and discharge testing of the aqueous lithium ion secondary battery of Comparative Example 2, and FIGS. 10 to 14 show the results of charge and discharge testing of the aqueous lithium ion secondary batteries of Examples 1 to 5. As is apparent from the result shown in FIG. 9, when the film was not formed for the anode of LTO, the aqueous electrolyte solution was electrolyzed at approximately 2.5 V, and no oxidation-reduction reaction of LTO was able to be confirmed.

In contrast, as is apparent from the results shown in FIGS. 10 to 14, when the film was formed for the anode of LTO, plateaus of LTO were observed in both charging and discharging.

In Example 1 shown in FIG. 10, while the charge capacity was 0.3 mAh, the discharge capacity was 0.15 mAh. That is, the coulombic efficiency was 50%.

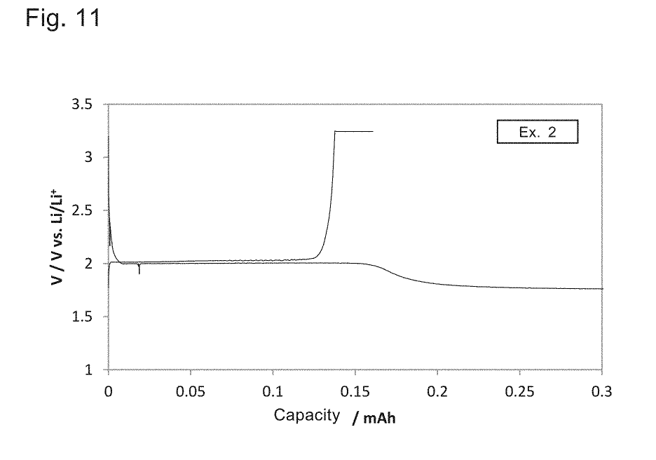

In Example 2 shown in FIG. 11, while the charge capacity was 0.2 mAh, the discharge capacity was 0.14 mAh. That is, the coulombic efficiency was 70%.

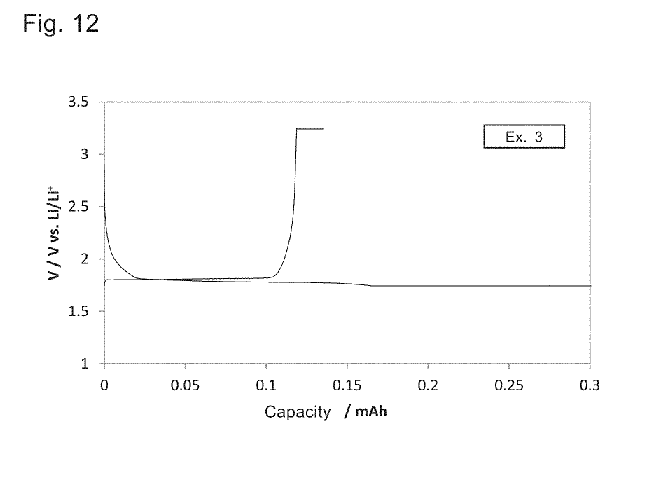

In Example 3 shown in FIG. 12, the discharge capacity of 0.12 mAh was obtained.

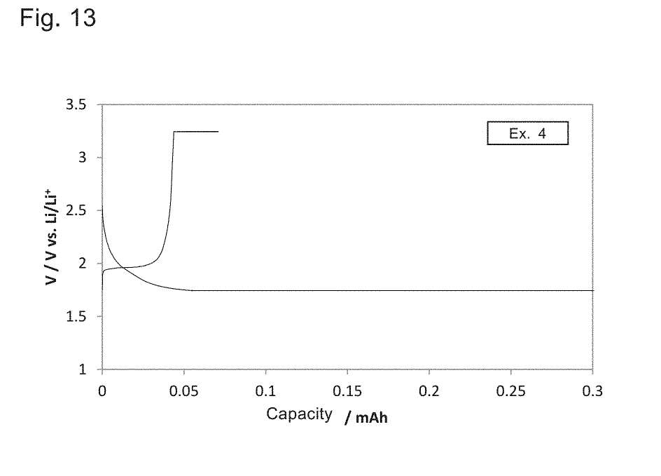

In Example 4 shown in FIG. 13, the discharge capacity of 0.04 mAh was obtained.

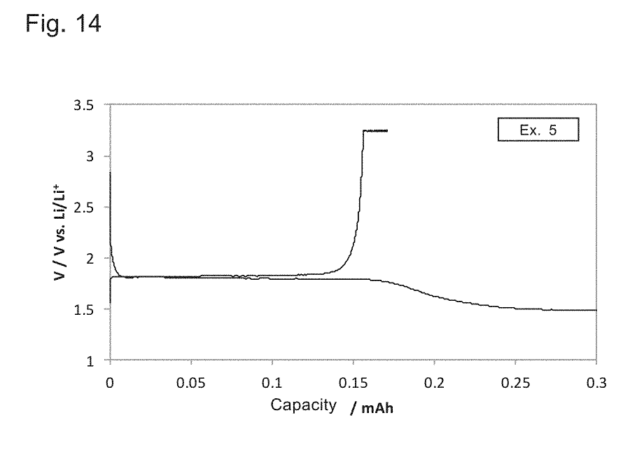

In Example 5 shown in FIG. 14, the discharge capacity of 0.15 mAh was obtained.

As described above, it was found that the anode of the aqueous lithium ion secondary battery is subjected to the film forming process in advance, which suppresses the reductive decomposition of the aqueous electrolyte solution in the aqueous lithium ion secondary battery, can expand an apparent reduction potential window of the aqueous electrolyte solution, and makes it possible to employ an anode active material that is conventionally difficult to be used.

Examples showed the case where LTO was used as the anode active material. The anode active material is not limited to LTO. As described above, forming the film over the surface of the anode expands the potential window of the aqueous electrolyte solution on the reduction side. Thus, the anode active material may be selected according to the potential window on the reduction side. The cathode active material is selected in the same manner as well.

Examples showed the case where LiTFSI was dissolved in the aqueous electrolyte solution at a concentration as high as 21 mol/kg. The concentration of the electrolyte in the aqueous electrolyte solution is not restricted to this. As described above, it is believed that even if forming the film over the surface of the anode reduces the concentration of the electrolyte in the aqueous electrolyte solution, the potential window of the aqueous electrolyte solution on the reduction side can be expanded. A low concentration of the electrolyte in the aqueous electrolyte solution has advantages such as a low viscosity of the aqueous electrolyte solution, a high velocity of travel of lithium ions, and improved power of the battery. The concentration of the electrolyte in the aqueous electrolyte solution may be determined according to the performance of the battery to be aimed.

### INDUSTRIAL APPLICABILITY

An aqueous lithium ion secondary battery using the anode of this disclosure has a high operating voltage, and can be used in a wide range of power sources such as an onboard large-sized power source, and a small-sized power source for portable terminals.

### REFERENCE SIGNS LIST

10 anode current collector
20 anode active material layer
   21 anode active material
   22 conductive additive
   23 binder
30 cathode current collector
40 cathode active material layer
   41 cathode active material
   42 conductive additive
   43 binder
50 aqueous electrolyte solution
51 separator
100 anode
200 cathode
1000 aqueous lithium ion secondary battery

1. A method for producing an anode for an aqueous lithium ion secondary battery, the method comprising:
a first step of touching an anode that is electrochemically kept in a reduction or oxidation state to a nonaqueous electrolyte solution in which a lithium salt is dissolved, to form a film over a surface of the anode; and
a second step of cleaning the anode, over the surface of which the film is formed.

2. The method according to claim 1, wherein
the nonaqueous electrolyte solution contains at least one organic compound selected from the group consisting of organic compounds each having a vinyl group, organosilicon compounds each including a carbon atom linked to a silicon atom that is next to the carbon atom, the carbon atom having a triple bond or a double bond, and organophosphorus compounds each including two or more oxygen atoms linked to a phosphorus atom that is next to the oxygen atoms.

3. The method according to claim 2, wherein
the organic compounds each having a vinyl group are at least one organic compound selected from the group consisting of vinylimidazole, vinylpyridine, methyl methacrylate, and styrene,
the organosilicon compounds are at least one organic compound selected from the group consisting of 1,4-bis(trimethylsilyl)-1,3-butadiyne, trimethylsilylacetylene, trimethoxyphenylsilane, and triethoxyphenylsilane, and
the organophosphorus compounds are at least one organic compound selected from the group consisting of (aminomethyl)phosphonic acid, and tris(2,2,2-trifluoroethyl) phosphate.

4. The method according to claim 2, wherein
at least one of the organic compounds each having a vinyl group is dissolved in the nonaqueous electrolyte solution, said at least one of the organic compounds each having a vinyl group having an aromatic ring including a nitrogen atom, and
in the first step, temperature of the nonaqueous electrolyte solution is 50° C. to 70° C.

5. The method according to claim 4, wherein
the organic compounds each having a vinyl group are at least one organic compound selected from the group consisting of vinylimidazole, and vinylpyridine.

6. The method according to claim 1, wherein the anode includes Li₄Ti₅O₁₂ as an anode active material.

7. A method for producing an aqueous lithium ion secondary battery, the method comprising:
producing an anode according to the method of claim 1;
producing a cathode;
producing an aqueous electrolyte solution; and
storing the anode, the cathode, and the aqueous electrolyte solution in a battery case.
